(19) United States
(12) Patent Application Publication
(10) Pub. No.: US 2007/0284549 A1
(43) Pub. Date: Dec. 13, 2007

(54) Optical reflective information reading sensor and electronic device

(75) Inventors: Kazuhiro Mizuo, Nara (JP); Shinya Kawanishi, Nara (JP)

Correspondence Address: NIXON & VANDERHYE, PC, 901 NORTH GLEBE ROAD, 11TH FLOOR, ARLINGTON, VA, 22203, US

(73) Assignee: Sharp Kabushiki Kaisha, Osaka (JP)

(21) Appl. No.: 11/790,151

(22) Filed: Apr. 24, 2007

(30) Foreign Application Priority Data
May 22, 2006 (JP) 2006-141656

(51) Int. Cl. G06K 7/10

(52) U.S. Cl. 250/555

(57) ABSTRACT

In one embodiment, an optical reflective information reading sensor has a single casing that accommodates a light-emitting element portion for emitting light for reading information, an emission-side lens portion for irradiating a target information face of a target with irradiation light, which is the light emitted by the light-emitting element portion, the target being disposed outside the optical reflective information reading sensor, a reception-side lens portion for forming an image of diffusely reflected light, which is reflected light of the light irradiated on the target information face, and a light-receiving element portion for receiving the diffusely reflected light whose image has been formed. The optical reflective information reading sensor detects a target information pattern, which is target information such as a barcode on the target information face.

### CROSS REFERENCE TO RELATED APPLICATIONS

This application claims priority under 35 U.S.C. § 119(a) on Patent Application No. 2006-141656 filed in Japan on May 22, 2006, the entire contents of which are hereby incorporated by reference.

### BACKGROUND OF THE INVENTION

1. Field of the Invention

The present invention relates to an optical reflective information reading sensor for detecting target information, by irradiating with light a target information face that holds target information such as barcodes, and detecting light reflected by the target information face, and an electronic device in which the optical reflective information reading sensor is installed.

2. Description of the Related Art

Sensors (optical information reading sensors) for reading barcodes are conventionally known. Most conventional sensors are for reading one-dimensional barcodes. In order to read two-dimensional barcodes, image sensors are usually used that have a two-dimensional structure, such as CCDs. In a case where a solid-state image pickup element such as a CCD is used, reading is similar to shooting with a camera, so that the configuration of lenses is complicated and components become expensive. Furthermore, a target cannot be detected without light, and thus detection cannot be performed in a dark place such as internal portions of printers.

Furthermore, a plurality of components are separately mounted on a conventional barcode sensor (see JP H8-240750A, for example), and thus there is a problem in that precision in reading barcodes is lowered due to non-uniformity in positions of the separately mounted components. In order to address the problem, it has been proposed that barcodes have data of positioning information in addition to their original data so as to improve the reading precision. However, when information other than the original data is added to barcodes, the barcodes become larger, and thus a barcode sensor becomes larger. Furthermore, it is difficult to apply this method to two-dimensional barcodes.

In conventional examples, one product (barcode sensor) is produced by separately assembling a plurality of components such as a light-emitting component, a light-receiving component, lenses, and peripheral circuits, so that there is a problem in that the characteristics are significantly changed by mounting errors, in addition to the problem that the barcode sensor becomes larger. When the barcode sensor is large, it is difficult to implement various barcode reading functions using the barcode sensors in internal portions of electronic devices. In the case of an apparatus for reading two-dimensional barcodes using a small CCD image sensor, the apparatus can be made small, but is extremely expensive.

### SUMMARY OF THE INVENTION

It is an object of the present invention to provide an optical reflective information reading sensor that can be made smaller and have higher precision, and that is produced with good productivity.

Furthermore, it is another object of the present invention to provide an optical reflective information reading sensor that is not influenced by the conditions of a target information face.

Furthermore, it is another object of the present invention to provide an optical reflective information reading sensor that can read one column of target information all at once.

Furthermore, it is another object of the present invention to provide an electronic device that has high precision in detecting target information.

The present invention is directed to an optical reflective information reading sensor, comprising: a light-emitting element portion for emitting light for reading information; an emission-side lens portion for irradiating a target information face that holds target information, with light emitted by the light-emitting element portion, as irradiation light; a reception-side lens portion for forming an image of reflected light of light with which the target information face is irradiated; a light-receiving element portion for receiving reflected light whose image has been formed; and a casing for accommodating the light-emitting element portion, the emission-side lens portion, the reception-side lens portion, and the light-receiving element portion.

With this configuration, an optical reflective information reading sensor is obtained that can read target information as one-dimensional information or two-dimensional information with high precision. Furthermore, since the constituents are accommodated in a single casing, downsizing, higher precision, and high productivity can be realized.

Furthermore, in the optical reflective information reading sensor according to the present invention, it is possible that the reflected light is diffusely reflected light.

With this configuration, reflected light can be detected while ignoring mirror reflected light, and thus target information can be stably detected without a significant influence of the surface conditions of the target information face.

Furthermore, in the optical reflective information reading sensor according to the present invention, it is possible that the irradiation light has an inclination angle of 10 to 45 degrees with respect to a direction perpendicular to the target information face.

With this configuration, detection precision can be improved by reliably generating diffusely reflected light, and thus an optical reflective information reading sensor with high reliability is obtained.

Furthermore, in the optical reflective information reading sensor according to the present invention, it is possible that the light-receiving element portion has a light-receiving face parallel to the target information face.

With this configuration, diffusely reflected light can be accurately detected, and thus an optical reflective information reading sensor with high precision is obtained.

Furthermore, in the optical reflective information reading sensor according to the present invention, it is possible that the light-receiving element portion is provided with a one-dimensional light-receiving element array.

With this configuration, one-dimensional target information can be detected easily and with good precision.

Furthermore, in the optical reflective information reading sensor according to the present invention, it is possible that two-dimensional target information is read, by performing scanning with the light-emitting element portion and the light-receiving element portion, or by performing scanning on the target information face.

With this configuration, two-dimensional target information can be detected easily and with good precision.

Furthermore, in the optical reflective information reading sensor according to the present invention, it is possible that the emission-side lens portion is a toroidal lens for irradiating all of one column of the target information with the irradiation light.

With this configuration, since all of one column of target information is irradiated with irradiation light, the one column of the target information can be read all at once.

Furthermore, in the optical reflective information reading sensor according to the present invention, it is possible that the focal length of the toroidal lens is set to correspond to a middle portion between a central portion and an end portion of the information in one column.

With this configuration, irradiation light on information in one column can be made uniform, and thus information can be read with high precision.

Furthermore, in the optical reflective information reading sensor according to the present invention, it is possible that in the toroidal lens, the width of a lens central portion corresponding to a central portion of the information in one column is smaller than the width of a lens end portion corresponding to an end portion of the information in one column.

With this configuration, the amount of irradiation light that passes through the lens central portion is smaller than the amount of irradiation light that passes through the lens end portion, and thus the intensity of irradiation light with which information in one column is irradiated can be made uniform, so that the light intensity on the target information face can be made uniform.

Furthermore, in the optical reflective information reading sensor according to the present invention, it is possible that the irradiation light has a width that is substantially the same as a unit length of the target information in a row direction intersecting a column direction of the information in one column.

With this configuration, one column of target information can be reliably read.

Furthermore, in the optical reflective information reading sensor according to the present invention, it is possible that a ratio between the distance from the light-receiving element portion to the reception-side lens portion and the distance from the reception-side lens portion to the target information face is approximated to a ratio between the distance from the light-emitting element portion to the emission-side lens portion and the distance from the emission-side lens portion to the target information face.

With this configuration, an optical reflective information reading sensor with high precision is obtained that is less influenced by offset of the light-emitting element portion or the light-receiving element portion.

Furthermore, in the optical reflective information reading sensor according to the present invention, it is possible that the light-emitting element portion and the light-receiving element portion are bonded to a single lead frame and separately sealed with a resin into respective primary resin sealing portions, and light between the primary resin sealing portions is blocked by resin-sealing with a secondary resin sealing portion.

With this configuration, the positional precision of the light-emitting element portion and the light-receiving element portion can be improved, and each of the light-emitting element portion and the light-receiving element portion can serve as an independent optical system that is not influenced by the other. Thus, an optical reflective information reading sensor is obtained that can detect target information with high precision.

Furthermore, in the optical reflective information reading sensor according to the present invention, it is possible that the secondary resin sealing portion has light transmitting portions for transmitting the irradiation light and the reflected light.

With this configuration, noise light from the surroundings can be removed, and thus target information can be detected with high precision.

Furthermore, in the optical reflective information reading sensor according to the present invention, it is possible that the light transmitting portions are formed as slits.

With this configuration, stray light can be reliably removed, and thus target information can be detected with high precision.

Furthermore, in the optical reflective information reading sensor according to the present invention, it is possible that the light-receiving element portion is configured with a CMOS image sensor, and the light-emitting element portion is configured with at least one LED.

With this configuration, an optical reflective information reading sensor is obtained that can be produced easily and at a low cost.

Furthermore, the present invention is directed to an electronic device in which an optical reflective information reading sensor is installed, wherein the optical reflective information reading sensor is the optical reflective information reading sensor according to the present invention.

With this configuration, an electronic device is obtained in which the optical reflective information reading sensor with improved precision in detecting target information is installed. Thus, in the electronic device, target information can be effectively used and reliability has been improved. Furthermore, the electronic device has high precision in detecting target information, because the optical reflective information reading sensor according to the present invention is installed therein.

### BRIEF DESCRIPTION OF THE DRAWINGS

FIG. 1 is a see-through side view of a structural outline of an optical reflective information reading sensor according to Embodiment 1 of the present invention.

FIG. 2 is a diagram showing the relationship between the reading area of the optical reflective information reading sensor according to Embodiment 1 of the present invention, and the target information pattern.

FIG. 3 is a view illustrating the outline of reading of two-dimensional information with the optical reflective information reading sensor according to Embodiment 1 of the present invention.

FIG. 4 is a diagram illustrating the relationship between the reading area of the optical reflective information reading sensor according to Embodiment 1 of the present invention, and the target information pattern.

FIG. 5 is a view illustrating a state in which all of one column of target information is irradiated with irradiation light when the optical reflective information reading sensor according to Embodiment 1 of the present invention is applied.

FIG. 6 is a view illustrating a state in which irradiation light is irradiated in the row direction intersecting the column direction of one column of the target information shown in FIG. 5.

FIGS. 7A and 7B are views illustrating the relationship between the irradiation light and the diffusely reflected light in the optical reflective information reading sensor according to Embodiment 1 of the present invention. FIG. 7A is a schematic side view showing a state of the irradiation light. FIG. 7B is a schematic side view showing a state of the diffusely reflected light.

FIGS. 8A to 8C are views illustrating examples of the toroidal lens that is applied to the optical reflective information reading sensor according to Embodiment 1 of the present invention. FIG. 8A is a plan view of the toroidal lens, viewed from the side of a convex portion. FIG. 8B is a side view of FIG. 8A, viewed in the direction indicated by arrow B. FIG. 8C is a front view of FIG. 8A, viewed in the direction indicated by arrow C.

FIG. 9 is a view illustrating the mounting structure for reducing the influence of offset of the light-emitting element portion or the light-receiving element portion in the optical reflective information reading sensor according to Embodiment 1 of the present invention.

FIG. 10 is a view of the schematic configuration of the main portions of an electronic device according to Embodiment 2 of the present invention.

### DESCRIPTION OF THE PREFERRED EMBODIMENTS

Hereinafter, embodiments of the present invention are described with reference to the drawings.

### Embodiment 1

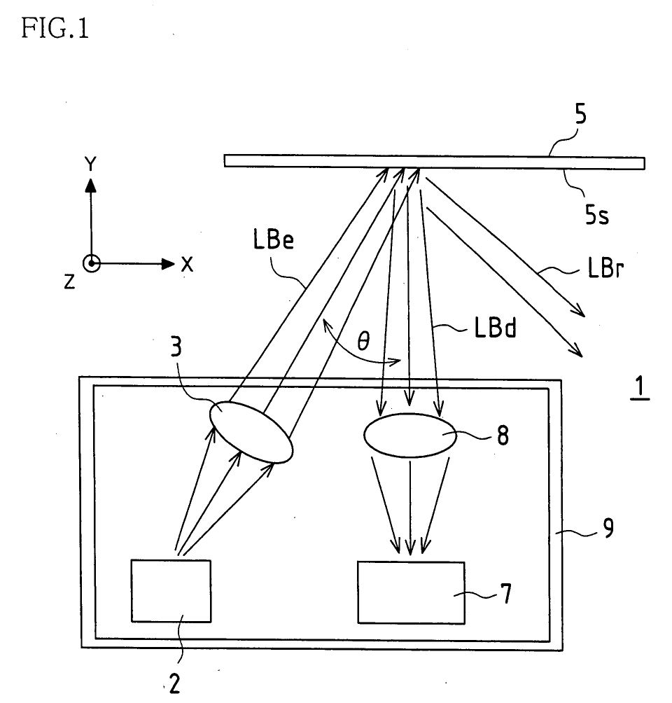

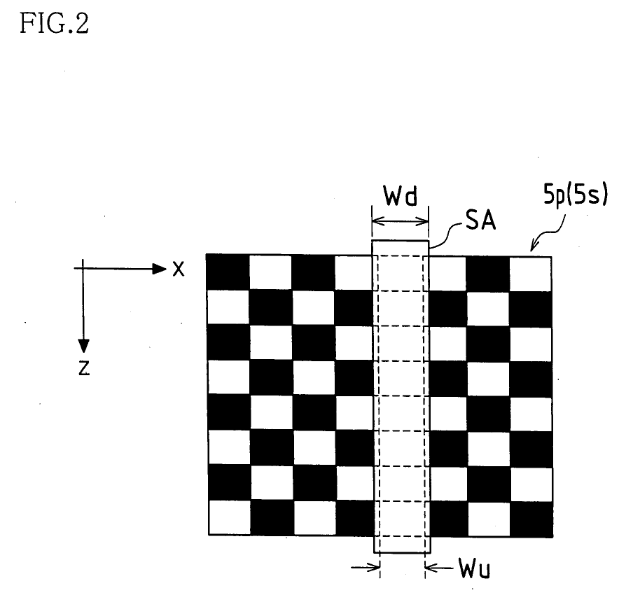

The structure of an optical reflective information reading sensor according to Embodiment 1 of the present invention and the manner in which it reads information are described with reference to FIGS. 1 and 2.

FIG. 1 is a see-through side view of a structural outline of an optical reflective information reading sensor according to Embodiment 1 of the present invention.

An optical reflective information reading sensor 1 according to this embodiment is provided with a light-emitting element portion 2 for emitting light for reading information, an emission-side lens portion 3 for irradiating a target information face 5s of a target 5 with irradiation light LBe, which is the light emitted by the light-emitting element portion 2, the target 5 being disposed outside the optical reflective information reading sensor 1, a reception-side lens portion 8 for forming an image of diffusely reflected light LBd, which is reflected light of the light irradiated on the target information face 5s, and a light-receiving element portion 7 for receiving the diffusely reflected light LBd whose image has been formed.

The light-emitting element portion 2, the emission-side lens portion 3, the light-receiving element portion 7, and the reception-side lens portion 8 are accommodated in a single casing 9. Since the main portions are collectively accommodated and arranged in the single casing 9, downsizing is possible, and precision in positioning of the main portions relative to each other can be improved. More specifically, this configuration provides the optical reflective information reading sensor 1 that can read with high precision a target information pattern 5p (see FIG. 2), which is target information (one-dimensional information or two-dimensional information), such as a barcode on the target information face 5s.

The light-emitting element portion 2 is configured with at least one LED (light-emitting diode). The light-receiving element portion 7 is configured with an image sensor. As the image sensor, it is particularly preferable to use a CMOS image sensor in view of detection precision, productivity, and cost.

The emission-side lens portion 3 is disposed in front of the light-emitting element portion 2, and narrows light emitted from the light-emitting element portion 2, thereby changing it into irradiation light LBe. The irradiation light LBe is changed into mirror reflected light LBr that is reflected by the target information face 5s at a reflection angle equal to the incident angle, and diffusely reflected light LBd that is diffused in a direction perpendicular to the target information face 5s.

The reception-side lens portion 8 is disposed in front of the light-receiving element portion 7, and forms, on the light-receiving element portion 7, an image of the diffusely reflected light LBd that is reflected by the target information face 5s. The mirror reflected light LBr is significantly influenced by the material and the surface shape of the target information face 5s (the target 5). In this embodiment, reflected light (the diffusely reflected light LBd) is detected while ignoring the mirror reflected light LBr. Thus, the target information pattern 5p can be stably detected without a significant influence of the surface conditions of the target information face 5s.

Herein, the arrangement of the light-emitting element portion 2 and the emission-side lens portion 3 is adjusted such that an image of the diffusely reflected light LBd is formed on the light-receiving element portion 7 in a state where the mirror reflected light LBr is removed. More specifically, the irradiation light LBe is set to have an inclination angle θ of 10 to 45 degrees with respect to the direction perpendicular to the target information face 5s. With this configuration, the detection precision can be improved by reliably generating the diffusely reflected light LBd, so that the optical reflective information reading sensor 1 with high reliability is obtained.

Furthermore, a light-receiving face of the light-receiving element portion 7 is disposed in parallel with the target information face 5s. With this configuration, the diffusely reflected light LBd can be accurately detected, so that the optical reflective information reading sensor 1 with high precision is obtained.

Herein, when the emission-side lens portion 3 is toroidal-shaped, the irradiation light LBe with which the target information face 5s is irradiated can be changed into a band-shaped spot beam that expands in the Z-direction of the coordinates in the drawings. In the X-direction and the Y-direction of the coordinates, the irradiation light LBe and the diffusely reflected light LBd can be configured to have appropriate directional characteristics, as described above. It should be noted that the irradiation light LBe is set to expand in the Z-direction of the coordinates (length direction of the band-shaped area) such that all of the information in one column on the target information face 5s (target information) is irradiated with the irradiation light LBe (see FIG. 2).

Accordingly, when the emission-side lens portion 3 is toroidal-shaped, all of the information in one column on the target information face 5s can be irradiated with the irradiation light LBe even in a case where the light-emitting element portion 2 is constituted by a small number of LEDs (one LED, for example). More specifically, the light-emitting element portion 2 can be made smaller. Since there is no need for a mechanism for operating the light-emitting element portion 2 such that all of the information in one column is irradiated with light from the light-emitting element portion 2, downsizing is possible, and production can be performed at a low cost by improving productivity.

Furthermore, since the light-receiving element portion 7 and the reception-side lens portion 8 are arranged together with the light-emitting element portion 2 and the emission-side lens portion 3, further downsizing and higher precision can be realized.

FIG. 2 is a diagram showing the relationship between the reading area of the optical reflective information reading sensor according to Embodiment 1 of the present invention, and the target information pattern.

On the surface of the target information face 5s, the target information pattern 5p, which is target information, is formed as two-dimensional information (in the X-direction and the Z-direction, for example). As described above, the irradiation light LBe is a band-shaped spot beam that expands in the Z-direction of the coordinates, so that all of the one column of the target information is irradiated with the irradiation light LBe. Thus, the irradiation light LBe with which the surface of the target information face 5s is irradiated forms an area SA of irradiation light for detection such that it corresponds to all of the information in one column.

Accordingly, the diffusely reflected light LBd from the band-shaped area SA of irradiation light for detection that corresponds to all of the information in one column can be detected with the light-receiving element portion 7. Furthermore, since expansion in the X-direction (width direction of the band-shaped area) is suppressed, it is possible to reduce the influence on information in another column that is adjacent to the one column on the target information face 5s, so that the information in one column can be reliably read with high precision. More specifically, the irradiation light LBe has a width Wd that is substantially the same as a unit length Wu of the target information in the row direction (width direction of the band-shaped area) intersecting the column direction of the information in one column. It should be noted that although the unit length Wu of the target information and the width Wd in the row direction of the irradiation light LBe are different in the drawings, they may be the same or may take any value, as long as the information in one column can be read.

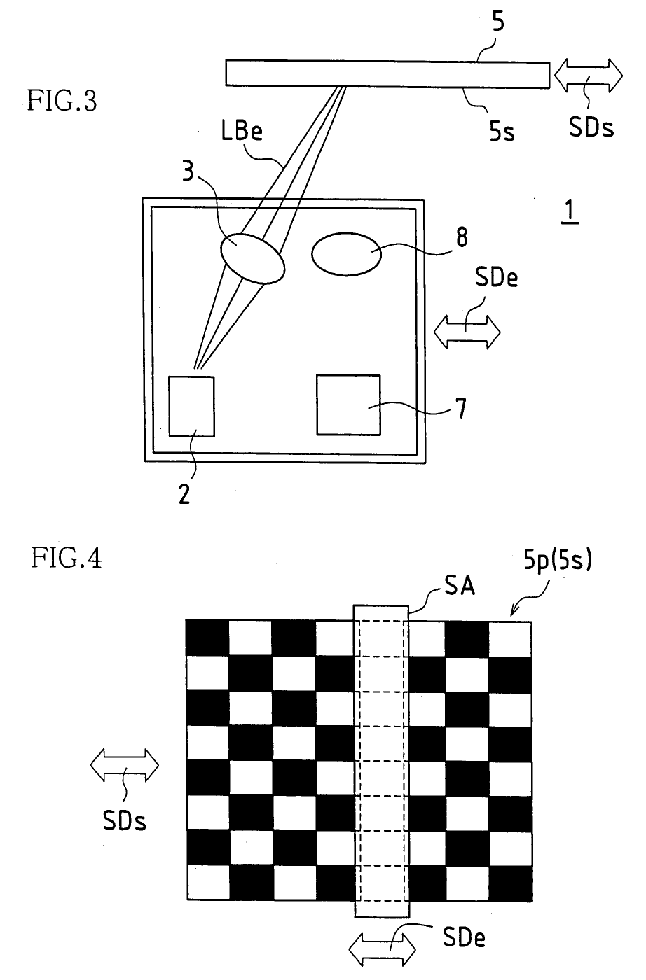

The light-receiving element portion 7 and the reception-side lens portion 8 are preferably configured with a one-dimensional light-receiving element array that can receive light corresponding to the area SA of irradiation light for detection such that the diffusely reflected light LBd from the area SA of irradiation light for detection can be reliably received and detected. With this configuration, one-dimensional target information (all of the information in one column) can be all at once detected easily and with good precision. Furthermore, two-dimensional target information can be detected (see FIGS. 3 and 4).

The manner in which the optical reflective information reading sensor according to this embodiment reads two-dimensional information is described with reference to FIGS. 3 and 4.

FIG. 3 is a view illustrating the outline of reading of two-dimensional information with the optical reflective information reading sensor according to Embodiment 1 of the present invention. FIG. 4 is a diagram illustrating the relationship between the reading area of the optical reflective information reading sensor according to Embodiment 1 of the present invention, and the target information pattern.

The configuration is basically the same as that shown in FIG. 1, and thus a detailed description thereof has been omitted as appropriate. As shown in FIG. 1, the irradiation light LBe is irradiated on all of the one column of the target information, and forms the area SA of irradiation light for detection. Accordingly, the target information pattern 5p on the target information face 5s constituted as two-dimensional information can be detected by performing scanning with the light-emitting element portion 2 and the light-receiving element portion 7 in a scanning direction SDe. At that time, the target information face 5s is fixed. More specifically, the target information (the target information pattern 5p) as two-dimensional information can be detected by performing scanning with the optical reflective information reading sensor 1.

It is also possible to detect the target information pattern 5p on the target information face 5s constituted as two-dimensional information, by fixing the optical reflective information reading sensor 1 and performing scanning on the target 5 (the target information face 5s) in a scanning direction SDs.

With this configuration including the scanning mechanism, two-dimensional information can be detected easily and with good precision.

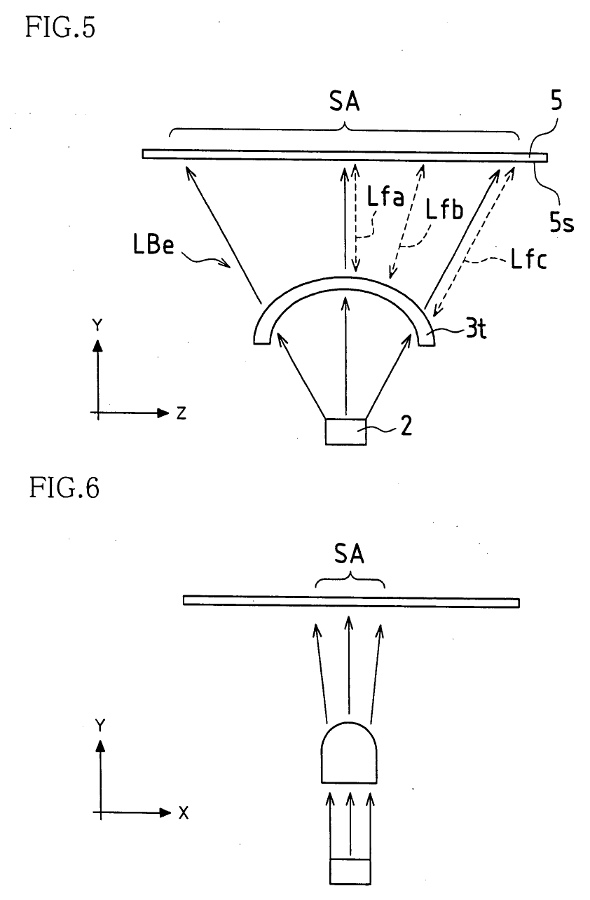

Examples of a toroidal lens that can be effectively applied to the optical reflective information reading sensor according to this embodiment are described with reference to FIGS. 5 to 8C.

FIG. 5 is a view illustrating a state in which all of one column of target information is irradiated with irradiation light when the optical reflective information reading sensor according to Embodiment 1 of the present invention is applied. FIG. 6 is a view illustrating a state in which irradiation light is irradiated in the row direction intersecting the column direction of one column of the target information shown in FIG. 5.

The configuration is basically the same as that shown in FIGS. 1 and 3. The Z-direction is the direction of one column of the target information. Accordingly, light emitted by the light-emitting element portion 2 passes through a toroidal lens 3t, irradiated on the target information face 5s as the irradiation light LBe, and forms the band-shaped area SA of irradiation light for detection (see FIGS. 2 and 4). More specifically, in FIG. 5, the horizontal direction corresponds to the length direction of the band-shaped area. In FIG. 6, the horizontal direction corresponds to the width direction of the band-shaped area.

The area SA of irradiation light for detection is preferably in the shape of a band having a uniform light intensity, in order to uniformly detect the one column of the target information. Thus, it is necessary to optimize the shape of the toroidal lens 3t. For example, if a length Lfa at the lens central portion is taken as the lens focal length, then the area SA of irradiation light for detection is thin at the central portion and thick at both ends, that is, a proper band shape cannot be obtained. If a length Lfc corresponding to the lens end portions is taken as the lens focal length, then the area SA of irradiation light for detection is thin at both ends and thick at the central portion.

Accordingly, the shape of the toroidal lens 3t is determined taking, as the lens focal length, a length Lfb corresponding to the average value of the length Lfa and the length Lfc. More specifically, the focal length is set to correspond to the middle portion between the central portion and the end portion of the one column of the target information.

With this configuration, the uniformity in thickness (width direction of the band-shaped area) of the area SA of irradiation light for detection can be improved.

The lens shape is designed using the length Lfb as a reference. At that time, when the lens is designed to have the shape of a band with appropriate width, it is possible to reduce the influence on detection precision caused by offset of the optical reflective information reading sensor 1 (the light-emitting element portion 2, or the light-receiving element portion 7, for example). More specifically, the area SA of irradiation light for detection shown in FIG. 6 has the width Wd (see FIG. 2) that is substantially the same as the unit length Wu of the target information in the row direction (see FIG. 2). With this configuration, the information in one column can be reliably read.

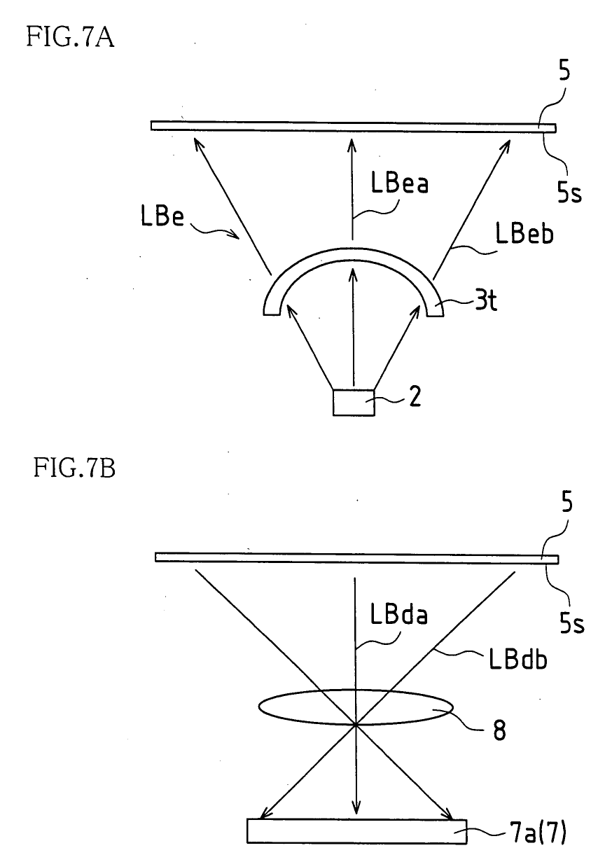

FIGS. 7A and 7B are views illustrating the relationship between the irradiation light and the diffusely reflected light in the optical reflective information reading sensor according to Embodiment 1 of the present invention. FIG. 7A is a schematic side view showing a state of the irradiation light. FIG. 7B is a schematic side view showing a state of the diffusely reflected light.

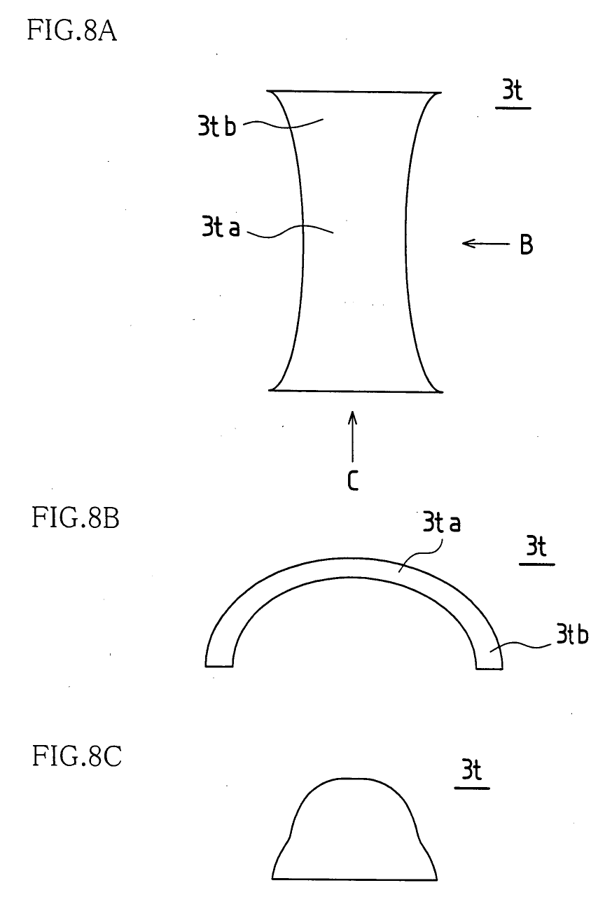

In order to reduce the detection non-uniformity between the vicinity of the central portion and both ends in the column direction of one column of the target information on the target information face 5s, it is preferable to adjust the intensity of the irradiation light LBea at a position corresponding to the central portion and the irradiation light LBeb at positions corresponding to both ends such that diffusely reflected lights LBda (reflected light of irradiation light LBea) and LBdb (reflected light of irradiation light LBeb) reaching the light-receiving element portion 7 (one-dimensional light-receiving element array 7a) have a uniform intensity in the column direction of the information in one column. FIGS. 8A to 8C show the structure of the toroidal lens 3t that realizes the features described in FIGS. 7A and 7B.

FIGS. 8A to 8C are views illustrating examples of the toroidal lens that is applied to the optical reflective information reading sensor according to Embodiment 1 of the present invention. FIG. 8A is a plan view of the toroidal lens, viewed from the side of a convex portion. FIG. 8B is a side view of FIG. 8A, viewed in the direction indicated by arrow B. FIG. 8C is a front view of FIG. 8A, viewed in the direction indicated by arrow C.

In view of the angles of the irradiation light LBea and the irradiation light LBeb, emitted from the light-emitting element portion 2, with respect to the target information face 5s, and the incident angles of the diffusely reflected light LBda and the diffusely reflected light LBdb with respect to the one-dimensional light-receiving element array 7a, it is necessary that the intensity (light intensity) of the irradiation light LBea is smaller than that of the irradiation light LBeb (see FIGS. 7A and 7B).

Accordingly, the width of a lens central portion 3ta corresponding to the central portion in the information in one column is made smaller than that of a lens end portion 3tb corresponding to the end portion in the information in one column. With this configuration, the irradiation light LBea that passes through the lens central portion 3ta can be made smaller than the irradiation light LBeb that passes through the lens end portion 3tb. Thus, the intensity of the irradiation light LBea and the irradiation light LBeb can be made uniform, so that distribution of the light intensity on the light-receiving face of the one-dimensional light-receiving element array 7a can be made uniform.

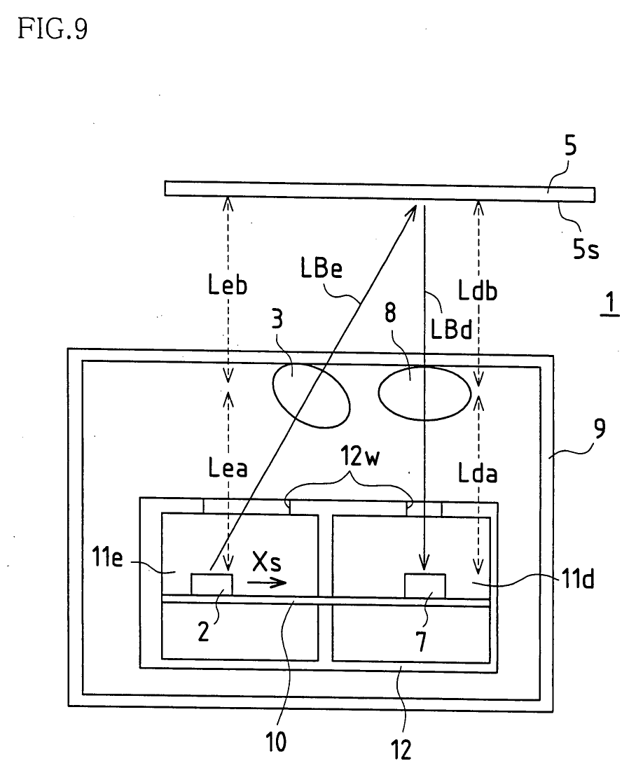

FIG. 9 is a view illustrating the mounting structure for reducing the influence of offset of the light-emitting element portion or the light-receiving element portion in the optical reflective information reading sensor according to Embodiment 1 of the present invention.

The configuration is basically the same as that shown in FIG. 1, and thus a detailed description thereof has been omitted as appropriate.

For example, if the light-emitting element portion 2 is offset by Xs (mm), then offset of the spot position on the target information face 5s is Xs×(distance Leb between emission-side lens portion and target information face)/(distance Lea between light-emitting element portion and emission-side lens portion) (mm). Furthermore, this offset of the spot position on the light-receiving element portion 7 is Xs×[(distance Leb between emission-side lens portion and target information face)/(distance Lea between light-emitting element portion and emission-side lens portion)]×[(distance Lda between light-receiving element portion and reception-side lens portion)/(distance Ldb between reception-side lens portion and target information face)] (mm).

In order to reduce the offset of the spot position on the light-receiving element portion 7, it is necessary not to increase the offset of the spot position on the target information face 5s. More specifically, it is necessary that a value of [(distance Leb between emission-side lens portion and target information face)/(distance Lea between light-emitting element portion and emission-side lens portion)]×[(distance Lda between light-receiving element portion and reception-side lens portion)/(distance Ldb between reception-side lens portion and target information face)] is equal or close to 1.

Accordingly, it is preferable that (distance Lea between light-emitting element portion and emission-side lens portion): (distance Leb between emission-side lens portion and target information face) is equal or close to (distance Lda between light-receiving element portion and reception-side lens portion): (distance Ldb between reception-side lens portion and target information face). In other words, the ratio between the distance Lda from the light-receiving element portion 7 to the reception-side lens portion 8 and the distance Ldb from the reception-side lens portion 8 to the target information face 5s is approximated to the ratio between the distance Lea from the light-emitting element portion 2 to the emission-side lens portion 3 and the distance Leb from the emission-side lens portion 3 to the target information face 5s.

When the distances between the light-emitting element portion 2, the emission-side lens portion 3, the light-receiving element portion 7, and the reception-side lens portion 8 are determined so as to realize the positional relationship described above, the optical reflective information reading sensor 1 with high precision is obtained that is less influenced by offset of the light-emitting element portion 2 or the light-receiving element portion 7.

Furthermore, when the light-emitting element portion 2 and the light-receiving element portion 7 are mounted on a single package, the offset of the light-emitting element portion 2 can be substantially the same as the offset of the light-receiving element portion 7. Thus, with the positional relationship described above, the offsets cancel each other, so that the influence of the offsets can be eliminated.

Thus, the light-emitting element portion 2 and the light-receiving element portion 7 are mounted on a single lead frame 10 (by bonding), and are separately sealed with a resin into respective primary resin sealing portions 11e (corresponding to the light-emitting element portion 2) and lid (corresponding to the light-receiving element portion 7). The light-emitting element portion 2 and the light-receiving element portion 7 are preferably placed on different lead pins and insulated from each other as appropriate, in order to eliminate an electrical influence therebetween. In FIG. 9, the lead frame 10 is shown as a single plate member in order to clearly show that it is a single unit, but the light-emitting element portion 2 and the light-receiving element portion 7 are actually connected to different lead pins formed on the lead frame 10.

Furthermore, it is necessary that light from the light-emitting element portion 2 does not directly reach the light-receiving element portion 7. Accordingly, the components are sealed with a resin by forming a secondary resin sealing portion 12 for blocking light, between the primary resin sealing portion 11e and the primary resin sealing portion 11d, and around the primary resin sealing portions 11e and lid. More specifically, each of the light-emitting element portion 2 and the light-receiving element portion 7 serves as an independent optical system, and thus the optical reflective information reading sensor 1 is obtained that can detect target information with high precision. It should be noted that light transmitting portions 12w for transmitting the irradiation light LBe and the diffusely reflected light LBd are formed as appropriate on optical paths of the irradiation light LBe and the diffusely reflected light LBd.

When the light transmitting portions 12w are formed as slits at which a sealing resin of the secondary resin sealing portion 12 is not placed, it is possible to remove stray light (noise light). Thus, the optical reflective information reading sensor 1 with high precision and high reliability is obtained. Furthermore, since a front face portion of the light-emitting element portion 2 and a front face portion of the light-receiving element portion 7 are provided with the slit-like light transmitting portions 12w, aberration by the emission-side lens portion 3 and the reception-side lens portion 8 can be reduced, and thus detection can be performed with higher precision.

### Embodiment 2

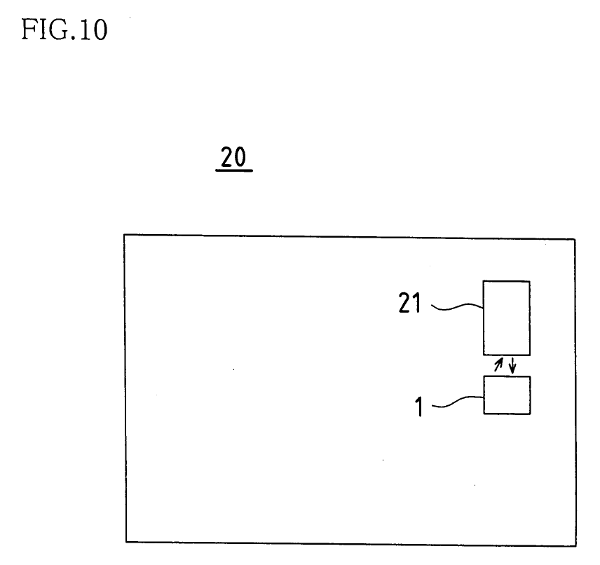

FIG. 10 is a view of the schematic configuration of the main portions of an electronic device according to Embodiment 2 of the present invention. It should be noted that although the present invention is specifically applied to a printer in this embodiment, the electronic device to which the present invention is applied is not limited to a printer.

When the optical reflective information reading sensor 1 according to Embodiment 1 of the present invention is housed/installed in a printer 20 as shown in FIG. 10, so that target information such as barcodes attached to ink tanks 21 is detected with high precision, it is possible to prevent setting errors of the ink tanks 21 by reading the type of the ink tanks 21. More specifically, in Embodiment 2 in which the optical reflective information reading sensor 1 according to Embodiment 1 is installed in an electronic device, an electronic device is obtained in which target information can be effectively used and reliability has been improved.

The present invention can be embodied and practiced in other different forms without departing from the gist and essential characteristics thereof. Therefore, the above-described embodiments are considered in all respects as illustrative and not restrictive. The scope of the invention is indicated by the appended claims rather than by the foregoing description. All variations and modifications falling within the equivalency range of the appended claims are intended to be embraced therein.

1. An optical reflective information reading sensor, comprising:
a light-emitting element portion for emitting light for reading information;
an emission-side lens portion for irradiating a target information face that holds target information, with light emitted by the light-emitting element portion, as irradiation light;
a reception-side lens portion for forming an image of reflected light of light with which the target information face is irradiated;
a light-receiving element portion for receiving reflected light whose image has been formed; and
a casing for accommodating the light-emitting element portion, the emission-side lens portion, the reception-side lens portion, and the light-receiving element portion.

2. The optical reflective information reading sensor according to claim 1, wherein the reflected light is diffusely reflected light.

3. The optical reflective information reading sensor according to claim 2, wherein the irradiation light has an inclination angle of 10 to 45 degrees with respect to a direction perpendicular to the target information face.

4. The optical reflective information reading sensor according to claim 3, wherein the light-receiving element portion has a light-receiving face parallel to the target information face.

5. The optical reflective information reading sensor according to claim 1, wherein the light-receiving element portion is provided with a one-dimensional light-receiving element array.

6. The optical reflective information reading sensor according to claim 5, wherein two-dimensional target information is read, by performing scanning with the light-emitting element portion and the light-receiving element portion, or by performing scanning on the target information face.

7. The optical reflective information reading sensor according to claim 1, wherein the emission-side lens portion is a toroidal lens for irradiating all of one column of the target information with the irradiation light.

8. The optical reflective information reading sensor according to claim 7, wherein the focal length of the toroidal lens is set to correspond to a middle portion between a central portion and an end portion of the information in one column.

9. The optical reflective information reading sensor according to claim 7, wherein in the toroidal lens, the width of a lens central portion corresponding to a central portion of the information in one column is smaller than the width of a lens end portion corresponding to an end portion of the information in one column.

10. The optical reflective information reading sensor according to claim 7, wherein the irradiation light has a width that is substantially the same as a unit length of the target information in a row direction intersecting a column direction of the information in one column.

11. The optical reflective information reading sensor according to claim 1, wherein a ratio between the distance from the light-receiving element portion to the reception-side lens portion and the distance from the reception-side lens portion to the target information face is approximated to a ratio between the distance from the light-emitting element portion to the emission-side lens portion and the distance from the emission-side lens portion to the target information face.

12. The optical reflective information reading sensor according to claim 1, wherein the light-emitting element portion and the light-receiving element portion are bonded to a single lead frame and separately sealed with a resin into respective primary resin sealing portions, and light between the primary resin sealing portions is blocked by resin-sealing with a secondary resin sealing portion.

13. The optical reflective information reading sensor according to claim 12, wherein the secondary resin sealing portion has light transmitting portions for transmitting the irradiation light and the reflected light.

14. The optical reflective information reading sensor according to claim 13, wherein the light transmitting portions are formed as slits.

15. The optical reflective information reading sensor according to claim 1, wherein the light-receiving element portion is configured with a CMOS image sensor, and the light-emitting element portion is configured with at least one LED.

16. An electronic device in which an optical reflective information reading sensor is installed, wherein the optical reflective information reading sensor is the optical reflective information reading sensor according to claim 1.
